(19) United States
(12) Patent Application Publication
(10) Pub. No.: US 2010/0092035 A1
(43) Pub. Date: Apr. 15, 2010

(54) AUTOMATIC RECOGNITION APPARATUS

(75) Inventor: Herbert Murdter, Albstadt (DE)

Correspondence Address: Schwabe Williamson & Wyatt;PACWEST CENTER, SUITE 1900, 1211 SW FIFTH AVENUE, PORTLAND, OR, 97204, US

(73) Assignee: METTLER-TOLEDO (ALBSTADT) GMBH, Albstadt (DE)

(21) Appl. No.: 12/441,694

(22) PCT Filed: Aug. 9, 2007
(86) PCT No.: PCT/EP07/07068

§ 371 Date: Dec. 8, 2009

(30) Foreign Application Priority Data
Sep. 20, 2006 (DE) 10 2006 044 365.9

(51) Int. Cl. G06K 9/00; H04N 7/18

(52) U.S. Cl. 382/103; 348/143; 348/E07.085

(57) ABSTRACT

The invention concerns an apparatus for automatic recognition of objects, which includes a device for capturing images of one object, or of a plurality of objects, which are to be recognized. The objects to be evaluated are manually introduced into a field of view of said camera. The invented apparatus possesses an image recognition device, whereby, from an image of an object within the field of view of the camera, an identification-signal representing the object is generated. The data acquired therefrom can serve, for example, a weighing scale, which has been equipped with the invented automatic recognition apparatus.

The invention concerns an apparatus for automatic recognition of objects, which includes a device for capturing images (hereinafter “camera”) of one object, or of a plurality of objects, which are to be recognized. The objects to be evaluated are manually introduced into a field of view of said camera. The invented apparatus possesses an image recognition device, whereby, from an image of an object within the field of view of the camera, an identification-signal representing the object is generated. The data acquired therefrom can serve, for example, a weighing scale, which has been equipped with the invented automatic recognition apparatus.

Automatic recognition apparatuses of this type are already known. These apparatuses are chiefly used in weighing units (hereinafter scales), whereby the weight and price of a product is automatically determined. The situation with known apparatuses is, that with today's do-it-yourself scales, a customer must identify the weighed product by use of a keyboard, thus allowing a price to be calculated. With the present invented recognition apparatus, upon weighing, the customer would be saved from this keyboard chore. A camera in the invented apparatus, can optically encompass the object to be recognized and generate an image. This image allows a recognition device to identify the said object. This recognition device is a element operating within the full automatic recognition apparatus and will be so described. A scale so equipped is disclosed in, for example, EP 0 443 419 B1.

A method for recognition by imaging is also known. In the basic principle of this known method, is a method of extracting from a produced image a characteristic pattern thereof, which can be compared with other images characteristic of the target object. In this manner, the object can be identified by that characteristic object image having a pattern exhibiting the greatest similarity to the actual image in the recognition apparatus. For example, a corresponding method is disclosed in EP 0 685 814 B1.

Generally, the reliability of known image recognition devices is not always satisfactory. In some instances, the method for identification ends without result, or the imaged object is provided with a false identification.

In view of the above stated problems of conventional automatic recognition apparatuses, the present invention has the purpose of making available an automatic recognition apparatus, which produces identification information of improved reliability.

Surprisingly, this purpose is achieved simply by a further development of the automatic recognition apparatus of the type described in the introductory passages, wherein the image recognition device is influenced by a detection unit which discovers the presence of a human hand in the field of view.

Within the limits of the invention, it is known, that a person's hand, which places the object to be identified into the field of view of the camera, or, better said, has brought the object therein, can lead to a deterioration of the image delivered to the image recognition device. When a hand interferes with the image, the image recognition device does not have the capability to extract from the resulting image sufficiently satisfactory identification data. As an example, an image recognition device may define objects as carrots from an inventory of possible objects, although the real objects in the field of view are apples even though the true image exhibits apples, and an apple product image has been made available for comparison. In the special case of an automatic recognition apparatus, where a do-it-yourself scale is involved, an increased danger arises, that a customer is not familiar with its automatic recognition principle and allows his hand to remain too long within the field of view of the camera, thus causing the imaging effect to deteriorate.

An erroneous function can be explained with the knowledge that a hand has hidden a relevant area of the object, so that the object becomes poorly depicted as a product image. Faulty procedures can be simply explained, in that instead of the image-pattern of a desired object, it is an image of a hand which is compared with other object images, whereby, in spite of the most convincing apparent agreement, nevertheless the wrong product is selected.

By means of the invented detection unit, which can discover a hand in the field of view, and which governs the image recognition device, a disturbance of the hand can be reacted to and measures counter to a detrimental state within the field of vision can be activated and a concurrently poorly generated image by the camera can be corrected, so that more reliable identification data can be achieved for the image recognition device.

In a case of a particularly simple version of the image recognition device, the detection unit continually compares successive images of the camera with one another and only releases data information when the said successive comparison, within a predetermined time period, has reached a satisfactory image agreement.

In this way, advantageously, the understanding is fully used, to the effect that the hand has a natural motion in relation to the object which is being brought into the field of view. If, within a predetermined time period, an image agreement is established, an operator can then assume that within the field of view no further motion exists. Thus it may be said, that an image “stillstand” has come into being, i.e., a motionless state has occurred and thus a hand is no longer within the field of view.

In a special manner, with this described version, no modification is required of the image recognition device in regard to recognition procedure. As an example, the image recognition device is not allowed to release identification data immediately, but rather can do so only after the determined “stillstand” exists. In other words, these data can be released only following a controlled, operational delay.

At the same time, the predetermined delay period is adjustable by, for instance, appropriate preliminary testing. In particular, it is possible that the limits of the said delay can be chosen to be so large, that inconsequent image fluctuations, which, as experience has shown, can occur even without the presence of a movable hand, still lie within the range of the predetermined delay period. Otherwise, the limits can be set so low, that typical hand movements within the field of view actually hinder the determination of an image agreement.

Procedures for the detection of image agreement are much simpler when presented as image recognition methods. These procedures are well known from the state of the technology. For example, the possibility exists, that images can be compared pixel by pixel, wherein the comparison would be limited by a tolerance threshold. If the differentiation of the compared images, within a predetermined count of pixels, is greater than the given tolerance, then an image “stillstand” cannot be declared.

In accord with an alternative version, the detection unit for image recognition is specifically designed for the hand, and blocks the generation of identification data in the automatic recognition device as long as the hand is present.

Contrary to the previous indirect detection of the presence of a hand, the detection unit, in this version, recognizes the hand immediately. The image recognition of the hand itself functions, for example, upon the same principle as does the image recognition of the object. Accordingly, it is possible that the hand itself can be a selected target-image for the detection unit. Especially, the possibility exists that the detection unit can functionally agree with the automatic recognition device, whereby the recognition spectrum expands itself to include the human hand.

This direct version of the automatic recognition device, when compared with that which is indirect in operation, is notably more reliable. Especially, a difference can be detected, as to whether or not a failed image agreement is actually caused by a hand or by other interferences.

In the case of an advantageous version, the automatic recognition device possesses an arrangement for the issuing of a warning signal, which signal is emitted, if the automatic recognition device, after the expiration of the said predetermined recognition time, and following the placement of at least one object, still does not produce the expected information data. By this warning signal, the user can be advised thereof, that his hand is still being detected within the field of view. The stated warning signal can be based on, for example, optical, acoustic, electro-acoustic, or other means for alarm.

Experience has shown, that a situation is advantageous, if the recognition time runs some six seconds or less, preferably four seconds or less, especially recommended at two seconds or less. Thus the extent of the duration, in which no progress in relation to the identification of the object is achieved, is characteristically held to a short time span. Also, within this operation provision can be made, that following the issue of a warning signal, the recognition delay can be automatically again restored. The result of this is that additional warning signals can be produced, especially if the user, as before, places his hand repeatedly in the field of view of the camera.

A warning signal can also be emitted, if the detection unit, following the expiration of a predetermined delay period recognizes a hand and after the placement of at least one object. Here it is advantageous, if the waiting period lasts one second or more, preferably two seconds or more, especially favorable, three seconds or more. A warning signal prior to the expiration of the waiting period would possibly irritate a user of the automatic recognition apparatus. Additionally, he must have sufficient time to withdraw his hand out of the field of view before an immediate warning signal is given.

In accord with still another version of the automatic recognition apparatus, wherein the automatic detection unit is again designed for image recognition of the hand but the production of identification data for the automatic recognition device can still be carried out because of an image component directed to the hand allows a corrected image.

This version is generally satisfactory, in that there is no need for a waiting period until the hand has been withdrawn from the field of view of the camera. Much more, the identification data is produced, in spite of the presence of the hand and the disturbances therefrom. In order, nevertheless, to assure a more reliable identification, the image is better corrected in its resolution by the above said image component. Accordingly the image improvement can be attributed to the already carried out recognition of the hand. In other words, the image pattern of the hand is filtered out of the workable image, so that the possibility of a false interpretation is diminished.

Advantageous to the detection unit is a memory bank for the storage of features of the human hand relative to its image recognition. This is especially arranged in regard to reference-imaging encompassing image patterns of the human hand. Accordingly the recognition of the hand is accomplished through a comparison of the produced image made by the automatic recognition device with at least one of the hand features or with at least one of the reference images. As has already been mentioned above, the recognition principle can be made by the comparison of patterns of the captured image with image patterns or reference images. Especially, it is possible, that advantageously, different hands in different positions can be input into the storage bank to serve as reference images in order to ease the recognition of the hand.

Considering another reliable version, the production of the identification data can be carried out on the basis of image patterns. The patterns employed have been made from a plurality of earlier images which were produced by the image capturing equipment after respective corrective measures for images of the hand had been completed. Should the hand have been moved during the time of the imaging, then different images become available for evaluation, whereby, for example, different characteristic areas of the object to be recognized must be carefully considered for the production of identification data.

Advantageously, the recognition equipment possesses a display arrangement for a real-time picture of the image which is being produced by the automatic recognition device. In this way, it is possible for the user to see as to whether or not his hands were in the field of view. The user then has the opportunity to remove his hands from the sensitive area.

In accord with a further point of view regarding the invention, a weighing scale especially designed for self-serve operation by a customer has been made available. This scale possesses a weight-sensitive cell for the determination of the weight value of an object set upon the receiving pan of the scale and also has, in accord with the invention, an automatic recognition system.

The invented scale is thus capable of not only determining the weight of a submitted product, but also reliably identifying the same. Advantageously, in this way the field of view of the automatic recognition apparatus at least complements the receiving platform of the scale, so that both the weight value and the identification of an object can be carried out at the same location.

Especially, under circumstances in which the scale is in a merchandising establishment, only products are brought to be weighed, which are in the normal inventory of the establishment. In an advantageous version, the scale possesses a memory bank, in which the product images of the said inventory are registered. With this advantage, it is possible for the image recognition device to search the memory bank to activate the identification data and/or to find characteristic information regarding the products of the said inventory. Under the classification of memory banks, are to be found all appropriately designed data-memories, wherein the content of said data bank can be advantageously changeable in order that the memory reflects in an actual manner any alterations in the inventory.

In accord with yet another advantageous variant of the scale, after the introduction of the product or products to be weighed, the detecting apparatus only becomes operable following a predetermined loading delay. With this arrangement, the exact time of the presentation of the product(s) can be defined, which is then registered by the said weighing cell. Additionally, the possibility exists wherein the weighing cell registers, as part of the weighing technology, the moment of “stillstand”. This would occur when the equipment is ready for the determination of the weight. Upon the operation of the detection unit following a waiting out period for the placement of the product, a termination of the action of a service person working in the loading operation can be carried out. The time span of scale loading lies, accordingly in a range of seconds, for instance this duration can last advantageously one second or more, or better two seconds or more, or, especially favorably, three seconds or more.

In a particularly well thought of arrangement of the automatic recognition apparatus, the scale assembly possesses display arrangement. On this equipment the product information saved in the data bank can be shown and/or a confirmation of a properly identified object can be exhibited. In addition, this display permits a narrowed threshold choice by scanning the identification data of chosen product images. This is an advantage in the customer-sided, final identification of the object. The said equipment can be any appropriate and known means of display, for instance a flat monitor screen.

The display arrangement can also possess a system for the emission of a warning signal, particularly, if optical warning signal are to be employed.

Obviously provision is also made, to the effect, that on the display arrangement, information on price per weight, a statement as to the weight as determined, the price of the identified product and/or additional information concerning the product can be shown.

Advantageously, the scale also includes means for input. This can be designed to provide certification of a displayed product identification for the customer and/or can be used to furnish an input of serviceable data of a final identification of the object. In particular, the input means can also be integrated into the display arrangement, for instance, in the form of a touch-screen.

Favorably, the scale also has a device for the automatic coordination of the determined weight and the product data for the identified object. This permits a computing unit to be included, which can immediately calculate a selling price from the determined weight and the price per weight unit of the identified object.

In an advantageous manner, a printer, can be provided. By this, data in regard to the identified object can be issued to the customer. The printed slips can be gummed labels, upon which the purchase information is printed, which information would include the determined weight and/or the wholesale price and/or the selling price.

In addition the scale possesses advantageously a control unit, which controls and coordinates at least part of the above mentioned apparatus. The scale also includes equipment for the transmission of control signals and data flows between components of this automatic recognition apparatus.

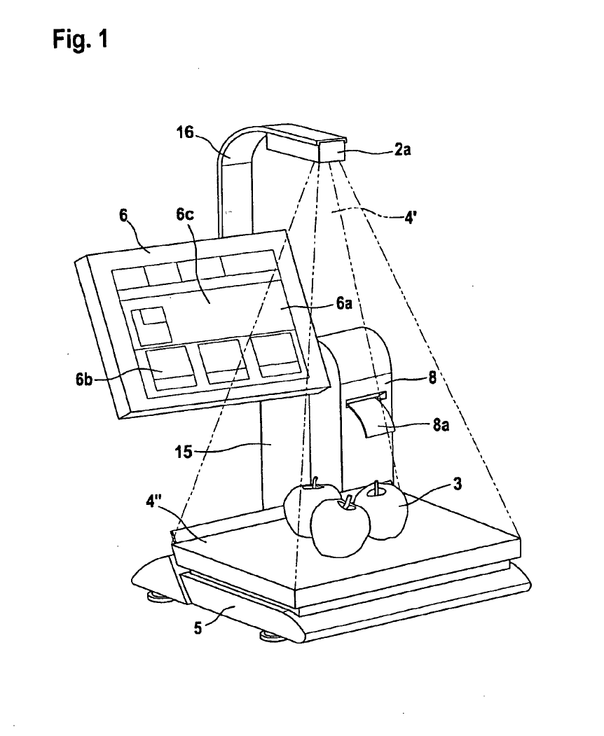

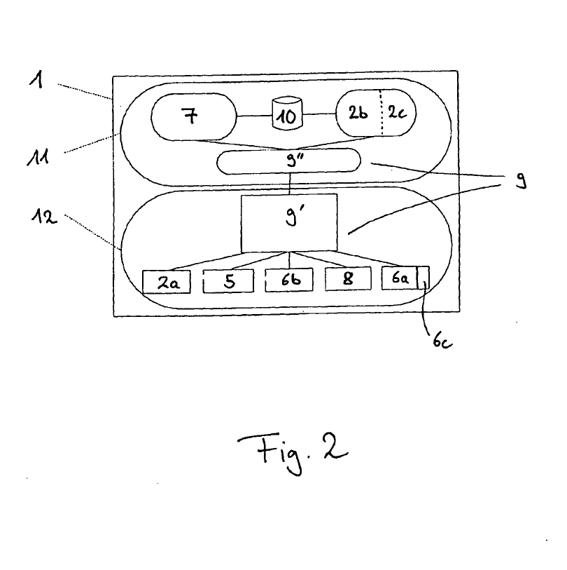

Additional details and advantages of the invention arise from the following description as shown on FIGS. 1 and 2 below. Accordingly, there is shown in:

FIG. 1: a plan view, inclined from the front, of the invented automatic recognition apparatus, and

FIG. 2: a schematic diagram, which depicts the hardware and software structure of the scale with the invented automatic recognition apparatus.

FIG. 1 shows scale 1 in accord with the invention. The scale 1 is comprised of a combination of assembled hardware elements, 12 (see FIG. 2), which are interconnected with one another and form a functional, operational unit.

The principal body of the scale 1 includes a flat, evenly designed base body into which a weighing cell 5 has been integrated. Above the weighing cell 5 is installed a flat receiving pan 4″, upon which, as is evident from FIG. 1, three apples 3 have been placed to serve as the products to be weighed and identified. At a rear area of the weighing cell 5, somewhat centrally located, rises a mid-section 15 of the principal body of the scale 1, in which, along with other elements, the software and hardware control 9, 9′, 9″ of the scale 1 is housed. Visible in FIG. 1 is the output of a printer 8 at the forward side of the mid-section 15. The printer 8 issued printed labels 8a, upon which at least the price of the identified and weighed product is shown.

Refer to FIG. 2 for details of the inner arrangement of the hardware platform 9 with the invented, automatic recognition device 2, a device 7 for weight determination and price computation (i.e., a correlating device) which is connected to the data bank 10. Also contained therewithin is a general software control 9″.

In the upper level of the mid-section 15 of the principle body of the scale 1 is to be found a touch screen 6, which is indicated as being similar to a flange, in that it extends itself to that side, which is opposite to the side of the base area and proximal to the mid-section 15. The said touch screen keyboard 6 simultaneously presents a display arrangement 6a and by its touch function area also an input means 6b. In addition proximally to the touch screen 6, optical warning elements could be shown.

In an upper area of the touch screen 6 is located a vertical structural member 16, which supports a camera 2a. This member 16 has been so installed that the field of view 4, 4′ of the camera 2a extends itself to the plane surface height of the receiving pan 4″ above the scale cell 5, which is essentially the receiving area of the pan 4″. The outline of the field of vision 4, 4′ of the camera 2a and the outline of the receiving pan 4″ predominately coincide. To assure the correct location and the orientation of the camera 2a, the camera supporting member 16 is placed on the upper part of the touch screen 6 at the side of the mid-section 15. This arrangement permits that the projection onto the receiving pan surface 4″ is essentially centrally located in reference to the said receiving pan surface 4″. Furthermore, the member 16 is fabricated with a rounded upper portion, so that its extended projection lies essentially parallel to the receiving pan 4″. The camera 2a, which is secured underneath the said projection of the member 16, is thereby so optically directed, that the receiving pan 4″ lies essentially exactly within the scope of its field of view 4.

When seen outwardly, the invented scale represents to a viewer the apparent image of a conventional scale.

The internal construction of the scale 1 is described in the following with particular reference to FIG. 2. In FIG. 2 is shown software algorithm units 11 and hardware module 12, the outlines of which show a provided PC operating system 9″ supported by a hardware platform 9′. These units form the control unit 9 for the regulation of the remaining components, apparatuses and software algorithm units. Additional hardware modules 12 include the above mentioned camera 2a, a weight sensor 5, a display arrangement 6a, which is integrated into the touch screen 6, a keyboard 6b as well as a printer 8. The equipment 6c, issues a warning signal for the information of the operator of the scale. This warning provides information regarding, for example, the disturbing presence of a hand in the field of view 4 of the camera 2 and is only presented schematically as part of the display arrangement 6a.

In regard to the software algorithm units, weight determination equipment and price computation means 7 are provided. These need not be particularly differentiated from conventional units for the same functions. The algorithms have access to the data bank 10 as does the image recognition system 2b, 2c. This image recognition system 2b, 2c possesses, for instance, a conventional image recognition system with corresponding image recognition software 2b, which, in this case, advantageously has a memory, which is supplied through the data bank and into which memory a plurality of product images have been stored. These product images can, for example, serve for comparison with images captured by the camera 2a, in order to identify the objects 3 brought into field of view of the camera 2a. Especially unusual in the image recognition system units 2b, 2c is the invented detection unit 2c, which has the capability to detect the presence of a hand in the field of view of the camera 2a and can also control the image recognition equipment 2b.

In the following, the operational method of the scale 1 is described and explained. A user of the said scale, namely a customer of a supplying company, to whom the self-serve equipment has been made available, places, as is shown in FIG. 1, three apples on the receiving pan 4″ of the scale. Since the camera 2a is located directly above the receiving pan 4″, then a horizontal plane of its field of view coincides therewith. Accordingly, the camera 2a can generate an image of the three apples 3. In a similar manner to conventional self-service scales, provision is made in that the apples 3 receive full recognition by the image registered in the image recognition system, namely the image recognition software 2b.

In an ideal case, the identification of the apples is achieved in a correct and straightforward manner and a corresponding product image is exhibited on the touch screen 6. The said customer must then confirm the given identification, either by exerting pressure on the exhibited product image or the printer 8 can, without such pressure, issue a stick-on label 8a. On this label will be shown the determined product weight and an identification symbol for the imaged apples 3. The selling price can be immediately computed by the weight determination/price calculating software 7. This calculation is done after a valid identification of the apples 3 has been completed. The price statement can print out on the said label 8a the wholesale price and the price per weight unit.

Although the above was confined to an “ideal case”, the recognition procedure does not always run without difficulties. For example, if a customer, who is not familiar with automatic recognition, operates the invented scale, he will have the concept, that he himself must seek out the product identification data. This he will do by browsing with finger pressures over the touch screen 6 to find a key responsive to his wish. He is unaware, that such action disturbs the automatic recognition of the apples 3 and that his hand is now within the scope of the field of view of the camera 2a.

With conventional automatic recognition apparatuses, the expectation would be that a breakdown, or a faulty identification of the apples 3 could be awaited. Such a functional error is avoided by the invented scale 1 because of the detection unit 2c.

In the version as shown in the attached FIGS. 1, 2, the emphasis, where the detection unit 2c is concerned, is not on an image recognition device, but more in regard to equipment which has the capability of comparing successively captured images of the camera 2a, one with another, and, with the aid of these successive images to determine whether or not a motion exists within the field of view 4. For this purpose, the said successive images are reviewed by the detection unit 2c to ascertain agreement of image repetition, which agreement is to be within the limits of the therefor predetermined tolerance threshold. If, within this tolerance limit an image agreement is confirmed, then procedure may be carried out to the effect that no hand is visible within the field of view 4 of the camera 2a and further the image recognition equipment 2b is released for the generation of the identification data of the observed object, as may be normally expected.

Where the version here is concerned, the detection unit 2c provides, that by the touch screen 6, an optical warning to the using customer is exhibited. This warning can be, for example, a very observable blinking screen dialog, such as “Please, remove your hand from the scale!”. In this way, the customer is informed, that he should remove the disturbing hand from the field of view 4. When this removal has been accomplished, then the blockage of the image recognition equipment 2b is released whereupon a a reliable product identification becomes possible.

Under certain circumstances, the optical warning signal can be enhanced by an acoustic alarm signal. For this warning extension, it is possible that the corresponding equipment 6c can be made more effective by the addition of a (not shown) small loud speaker.

As an alternative, the detection unit 2c can also be so designed, that the hand itself can be actively recognized. To achieve this the image recognition system 2b, 2c is to be so rebuilt, that, for example, the human hand is given consideration as a possible target image in the case of the image recognition routine.

If the detection unit 2c becomes aware of the hand, for example, within two seconds of the placement of the apples 3 on the receiving pan 4″, then a corresponding warning signal is issued in the manner described above. The blockage of the subsequent generation of the data can then only be released when the disturbing hand is removed from view.

To take advantage of another, time saving version, if the detection unit 2c is placed together with the image recognition equipment 2b, then an improved image recognition system 2b, 2c can be achieved. In such a case, the identification data is generated, although the hand is still observable. In order to reliably identify the apples 3, the image recognition system 2b, 2c filters the image pattern of the visible hand out of the image produced by the camera 2a so that system operation proceeds with the now filtered image. In this way, disturbing image patterns are removed, which otherwise could lead to a faulty identification such as the above mentioned identification of carrots for apples. In a further improved image recognition system 2b, 2c, it is possible that even a plurality of successive images of the camera 2a could be filtered and brought in for the identification of the apples 3.

The invention improves conventional, automatic recognition equipment 2 to the extent that the image recognition equipment 2b is controlled by the detection unit 2c which picks up the presence of a hand in the field of view 4 of the camera 2a. The invention, however, is not limited by the constructions presented in the above versions. Much more, the disclosed features in the above description as well as the features in the following claims, in individual as well as in combinatory version characteristics are important for the realization of the invention.

1. An apparatus for the automatic recognition of objects, with an image generating device, in the field of view of which at least one of the objects to be identified can be manually inserted, and having an image recognition device from which, due to an image of inserted object(s) created in the field of view by the said image generating device, data to serve for the identification of the said object can be generated, therein characterized, in that an image recognition device is overridden by detection unit, which determines the presence of a hand within the said field of view.

2. An apparatus in accord with claim 1, therein characterized, in that the detection unit compares successively following images from the image generating equipment and the image recognition device for the generation of the identification data is only released if, by the comparison within a predetermined threshold, an image agreement has been attained.

3. An apparatus in accord with claim 1, therein characterized, in that the detection unit is designed for the detection of a hand image and said equipment functions to establish a blockage of generation of information data by the image recognition device as long as the hand is being recognized

4. An apparatus in accord with claim 1, with a warning unit for the issuance of a warning signal, which signal is emitted if the image recognition device, following a predetermined recognition period after the placement of the at least one object, has not yet been released to permit the generation of the identification data.

5. An apparatus in accord with claim 4, therein characterized, in that the recognition period has a duration of six seconds or less, preferably four seconds or less, and especially favorably, two seconds or less.

6. An apparatus in accord with claim 3, with a unit for the issuance of a warning signal, which signal is issued if the detection unit discovers the presence of a hand image, following the duration of a predetermined time period after the placement of the at least one object.

7. An apparatus in accord with claim 6, therein characterized, in that the delay for agreement period has a duration of one second or more, preferably two seconds or more, and most favorably, three seconds or more.

8. An apparatus in accord with claim 1, therein characterized, in that the detection unit is designed for an image recognition of a hand and the generation of the identification data is to be carried out by the image recognition device under circumstances wherein the image is free of hand exposure.

9. An apparatus in accord with claim 3, therein characterized, in that the detection unit is installed with a storage means for the retention of reference images, wherein said images possess patterns of human hands and the recognition of the hand is obtained by comparison of an image which has been created by the image generating equipment.

10. An apparatus in accord with claim 8, therein characterized, in that the generation of information data is carried out on the basis of image patterns from a plurality of images produced by the image generating equipment which have been subjected to an effective removal of corresponding images of a hand.

11. An apparatus in accord with claim 1, characterized by a display arrangement to present a real time exhibit of the image generated by the image generating equipment.

12. A weighing unit, especially constructed for a customer's self-serve use, including a weighing cell for the determination of the weight of an object or objects placed upon receiving pan of said weighing unit, characterized by an automatic recognition device in accord with claim 1.

13. A weighing unit in accord with claim 12, characterized by a storage means, in which the images of the product of an inventory are retained and into which the image recognition device can refer for the generation of identification information and/or into which characteristic data regarding the products of the inventory can be input.

14. A weighing unit in accord with claim 12, therein characterized in that the detection unit is operable after the placement of the object(s) to be weighed.

15. A weighing unit in accord with claim 12, characterized by a display unit for a visual presentation of one or more product images selected by information data on the basis of recognition and confirmation of valid identification data and/or for a visual presentation of a limited selection to enable a customer-sided, final identification of the object and/or for display regarding price per unit weight, the determined weight and price of the identified object and/or to show additional information which relates to the weighed object.

16. A weighing unit in accord with claim 12, characterized by a keyboard for a customer centered confirmation of a displayed product identification and/or for the input of data serviceable for the final identification of the object.

17. A weighing unit in accord with claim 12, characterized by a weight determination unit for the automatic correlation of determined weight and product data of the identified object, especially serviceable for the computation of the selling price of the identified object.

18. A weighing unit in accord with claim 12, characterized by a printing unit, by means of which the determined weight and/or additional product data in regard to the identified object is printed on an adherent label and issued to the user.

19. A weighing unit in accord with claim 12, characterized by a control unit for the overall regulation of the image generating equipment, image recognition device, detection unit, warning unit, cell, display unit, keyboard, correlating unit, and/or the printer and for regulation of a means for the transmission of control signals and data flow within the described apparatus.
